(19) United States
(12) Patent Application Publication
(10) Pub. No.: US 2007/0199206 A1
(43) Pub. Date: Aug. 30, 2007

(54) Drying system for image forming machine

(76) Inventors: NamJeon Park, Anyang-si (KR); YunJoo Moon, Sungnam-si (KR); DongMin Kim, Seoul (KR); JungMi Oh, Seoul (KR); ByungChul Kyun, Uiwang-si (KR); SoonJae Moon, Kwangmyung-si (KR); JunHo Lee, Anyang-si (KR)

Correspondence Address: KIMBERLY-CLARK WORLDWIDE, INC., 401 NORTH LAKE STREET, NEENAH, WI, 54956, US

(21) Appl. No.: 11/362,299

(22) Filed: Feb. 24, 2006

(51) Int. Cl. F26B 3/00; F26B 13/00; F26B 19/00

(52) U.S. Cl. 34/443; 34/638; 34/68

(57) ABSTRACT

There is provided a drying system for an image forming machine which has a plenum and nozzle to supply drying air to impinge upon a moving substrate, where the air impinges upon the substrate in substantially the same direction in which the substrate is moving, and where the air impinges upon the substrate immediately after a colorant has been deposited upon the substrate and before it touches another object.

### BACKGROUND OF THE INVENTION

Wide format image forming machines are used for printing complex patterns on various substrates like paper, films, nonwoven fabrics, woven cotton, canvas, silk, polyester, nylon, Lycra® and other materials. These printers or image forming machines are capable of producing images on substrates having widths of greater than about 36 inches (910 mm) at relatively high speeds. Such wide format applications include the creation of images on mattress covers and bedspreads, automotive fabrics, upholstery, architectural applications, signs and banners and the like.

Wide format image forming machines generally have a printing head mounted above the substrate. The printing head moves across the substrate, perpendicular to the direction of motion of the substrate. As the printing head moves from side to side across the substrate, it deposits colorant (typically in the form of an ink or dye) to form an image in a predetermined pattern, conventionally controlled by a computer system.

The shear size of the image forming machine used in wide-width printing presents the user with a variety of technical problems. Existing substrate feeding systems, for example, can result in substrate stretching, misalignment, wrinkling, and bleeding as the substrate is feed over plates and between pinch rolls. Improper drying of the substrate can result in smearing of the colorant on the substrate or on parts of the image forming machine in existing systems because inadequate time and distance are available to completely dry after deposition of the colorant. Some current systems use a draping system in which the substrate is hung in fanfold arrangements until it is completely dried. In addition, current systems also have difficulty in adapting to substrates of varying thicknesses. Current image forming machines are able to adapt to variations in substrate thickness of up to about 1 mm from the machine's built in or pre-set thickness capability the printing head is moved vertically while the feed system is held stationary, to accommodate thicker substrates and the range of this movement is limited.

The complexity of these image forming machines presents another challenge to the designer as modifications and changes to existing systems must be capable of fitting into relatively small spaces. There is very little distance between the printing zone and the first point of contact of the substrate with another object, resulting in un-dried colorant contacting the object and smearing. In addition, certain types of printing heads are quite fragile and must be treated with the utmost care lest they be damaged. The close tolerances required in the making of such machines allow for the creation of high quality images, but make successful modification of the machine quite difficult.

It is an object of this invention to provide an image forming system that improves the quality of the substrate produced by reducing the amount of colorant smearing that occurs while the substrate is being printed.

BRIEF DESCRIPTION OF THE FIGURES

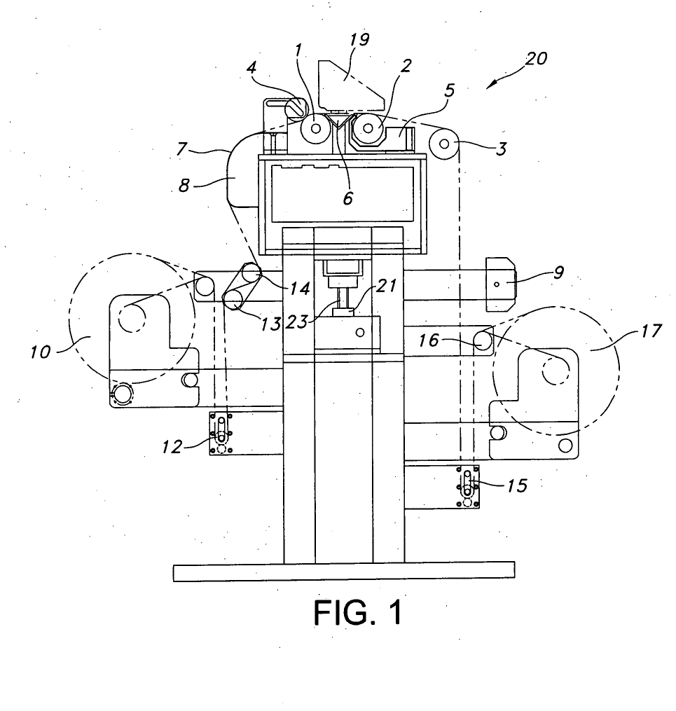

FIG. 1 is a diagram of an image forming machine feed system having the dryer of this invention.

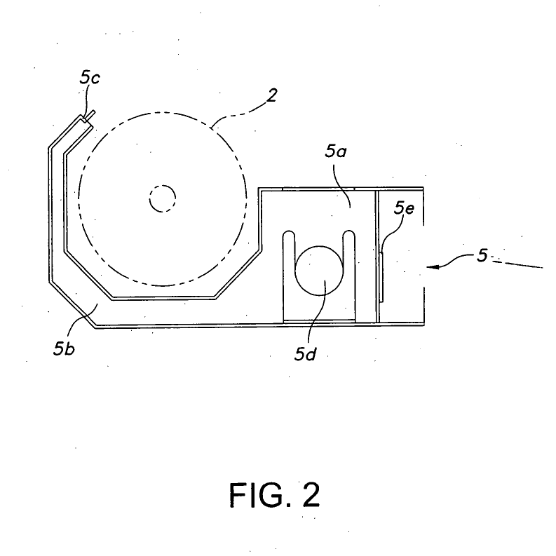

FIG. 2 is a cross-sectional view of the dryer of this invention in relation to a feeder roll of an image forming machine feed system.

### SUMMARY OF THE INVENTION

The inventors have found that if the drying medium (conventionally, heated air or other conventional gases) is impinged upon the underside of the printed substrate before the substrate contacts the first surface after being printed, the quality of the printed image can be improved and colorant smearing can be reduced. The drying medium should impinge the substrate with a strength or force that will not result in rippling or substantial displacement of the substrate and should be moving in a direction similar to that of the substrate.

Other features and aspects of the present invention are discussed in greater detail below.

### DETAILED DESCRIPTION

Turning to FIG. 1 one can see that the dryer 5 of the invention is part of a feeding system 20 including three feeder rolls (1, 2, 3) and a press roll 4 arranged around an ink tray 6 containing a colorant located in the printing zone. The printing zone is the area where the printing head unit 19 travels perpendicularly to the direction of movement of the substrate. FIG. 1 shows the invention in the X and Y planes and the movement of the printing head is in the Z direction.

The substrate is taken from a supply roll (not shown) and between the driven first feeder roll 1 and the un-driven press roll 4. Since the press roll 4 is un-driven, it moves only because of friction with the substrate 7 which is moved by the driven feeder rolls. As the substrate 7 moves from left to right in FIG. 1, it then passes into the printing zone; the location of the ink tray 6 as mentioned above, and on to the second feeder roll 2, which is also driven. The substrate is printed upon in the printing zone. Conventionally, this first point of contact between the now-printed substrate and another object (the second feeder roll 2) is the point at which undried colorant may be smeared and damage the quality of the substrate (in substrate not having a backing). In the current invention, heated air is directed upward toward the substrate 7 from the dryer 5 to dry the colorant sufficiently in order to avoid this problem. After passing over the second feeder roll 2 the substrate 7 passes above the dryer 5 and to the third feeder roll 3. After feeder roll 3 the substrate is taken to a wind-up operation (not shown).

As can be seen in FIG. 2, the dryer 5 has a plenum 5a which supplies air to the dryer duct 5b which discharges air at nozzle 5c to impinge on a substrate from below. The unique design of the dryer of this invention allows it to be placed in very close proximity to the feeder roll 2 and thus allows it to dry the substrate 7 before it is touched by another object. The dryer plenum 5a is on one side of the second feeder roll 2 but the dryer duct 5b passes below the second feeder roll 2 and curves around the second feeder roll 2 and upward toward the substrate 7 where the nozzles 5c are located.

It should be noted that the nozzle 5c may be a single slot shaped nozzle or may be a plurality of individual nozzles aligned along the width of the image forming machine. The slot or individual nozzles may further be opened or closed in sections or individually through conventional control valve technology. Similarly, the angle at which the air is blown onto the substrate can be changed in order to optimize drying and image quality concurrently. It is desirable that the drying air impinge upon the substrate in substantially the same direction as the direction of movement of the substrate and at a velocity that will not cause movement of the substrate (e.g. rippling).

As noted in Figure e, within the plenum 5a of the dryer 5 may be located a heater or heaters 5d for warming the air to be discharged onto the substrate 7. The heater may also controlled by conventional means so that warmer heated air may be supplied to one portion of the width of the substrate while cooler heated air or unheated air may be supplied to another. Air is moved by a fan or more particularly fans 5e, located along the width of the dryer plenum 5 and such fans 5e may be individually controlled. It should be clear that the arrangement and control of air fans, heater elements and nozzle adjustment techniques gives the operator of the machine a myriad of control options to optimize the functioning of the machine. This results in greatly improved printed substrate quality. The temperature and air velocity needed to dry a particular type of substrate and particular type of colorant will of course vary. These factors will also be influenced by the speed at which the substrate is moving. The temperature and volume of the heated air or gas will also be influenced by the type of substrate (e.g., porosity, absorbency) and the type of colorant. Generally speaking, however, if the substrate is moving at a speed between 1 and 30 meters per hour, more particularly between 5 and 20 meters per hour, the temperature may be between about 10 and 100° C., more particularly between about 30 and 60° C. The air velocity, as noted above, should be sufficient to dry the substrate without causing substrate movement (e.g. rippling). The air velocity may therefore be between about 1 and 10 m/sec, more particularly between about 2 and 7 m/sec.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A drying system for an image forming machine comprising a plenum and nozzle to supply drying air to impinge upon a substrate moving in a direction, wherein said air impinges upon said substrate in substantially the same direction in which said substrate is moving, and wherein said air impinges upon said substrate immediately after a colorant has been deposited upon said substrate and before said substrate touches another object.

2. The drying system of claim 1 wherein said image forming machine has a width of at least 36 inches (910 mm).

3. The drying system of claim 2 wherein said air impinges upon said substrate from below.

4. The drying system of claim 3 wherein said air impinges upon said substrate at a velocity that does not ripple said substrate.

5. The drying system of claim 4 wherein said plenum comprises at least one heater and at least one fan.

6. The drying system of claim 1 wherein said plenum comprises a plurality of nozzles.

7. The drying system of claim 6 wherein said nozzles may be individually opened and closed.

8. A method of drying a printed substrate in an image forming machine comprising the steps of applying colorant to a substrate, impinging air upon said substrate at a temperature and speed sufficient to dry said colorant prior to contacting said substrate on another object.
